(19) United States
(12) Patent Application Publication
(10) Pub. No.: US 2011/0161259 A1
(43) Pub. Date: Jun. 30, 2011

(54) SYSTEM AND METHOD FOR SIMPLIFICATION OF A MATRIX BASED BOOSTING ALGORITHM

(75) Inventor: CHENG-HSIEN LEE, Tu-Cheng (TW)

(73) Assignees: HON HAI PRECISION INDUSTRY CO. LTD., Tu-Cheng (TW); MASSACHUSETTS INSTITUTE OF TECHNOLOGY, Cambridge, MA (US)

(21) Appl. No.: 12/649,359

(22) Filed: Dec. 30, 2009

(51) Int. Cl. G06F 15/18; G06F 15/16

(52) U.S. Cl. 706/12; 709/217

(57) ABSTRACT

A method for simplification of a matrix based boosting algorithm divides a feature set comprising a plurality of feature data into several subsets, and assigns a number to each subset. The method selects a plurality of number groups including N subsets randomly. The method further computes a value by boosting algorithm according to each of the number groups for obtaining an acceptable false positive value.

### BACKGROUND

1. Technical Field

Embodiments of the present disclosure generally relate to systems and methods for processing data, and more particularly to a system and a method for the simplification of a matrix based boosting algorithm.

2. Description of Related Art

Machine learning is a scientific discipline that is concerned with the design and development of algorithms that allow computers to change behavior based on given data, such as data from sensors or databases. A major focus of machine learning research is to automatically learn to recognize complex patterns and make intelligent decisions based on given data.

Boosting algorithms are machine learning meta-algorithms for performing supervised learning. A boosting algorithm can be used to find combinations of feature data and reduce false positive (FP) value gradually through feedback of detection error and iteration, thus, can be used to implement object detection efficiently and easily.

There are many methods for implementation of boosting algorithms. Among these methods, matrix based (such as, weighted least square) methods can not only be easily implemented but also result in smaller FP value during shorter operation time than many other methods. However, original matrix based methods require performing matrix operations through whole feature data. Thus, large amounts of memory space and operation time are required as the feature data increase.

### BRIEF DESCRIPTION OF THE DRAWINGS

FIG. 1 is a block diagram of one embodiment of a system for simplification of a matrix based boosting algorithm.

FIG. 2 is a block diagram illustrating one embodiment of function modules of a data processing device in FIG. 1.

FIG. 3 is a flowchart of one embodiment of a method for simplification of a matrix based boosting algorithm.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

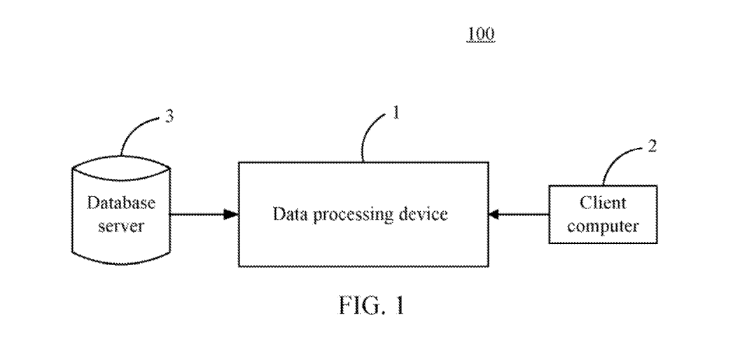

FIG. 1 is a block diagram of one embodiment of a system 100 for simplification of a matrix based boosting algorithm. In one embodiment, the system 100 includes a data processing device 1, a client computer 2, and a database server 3. The data processing device 1 connects to the client computer 2 and the database server 3 electronically. The data processing device 1 includes a plurality of function modules (see below descriptions) operable to simplify the matrix based boosting algorithm. The client computer 2 provides a user interface, which is used for receiving parameters for implementing the operation of simplifying the matrix based boosting algorithm. The database server 3 stores given data. The given data may be face recognition data, for example. The given data includes feature data and non-feature data. The feature data may be data representing a person's eyes, nose, and mouth, for example.

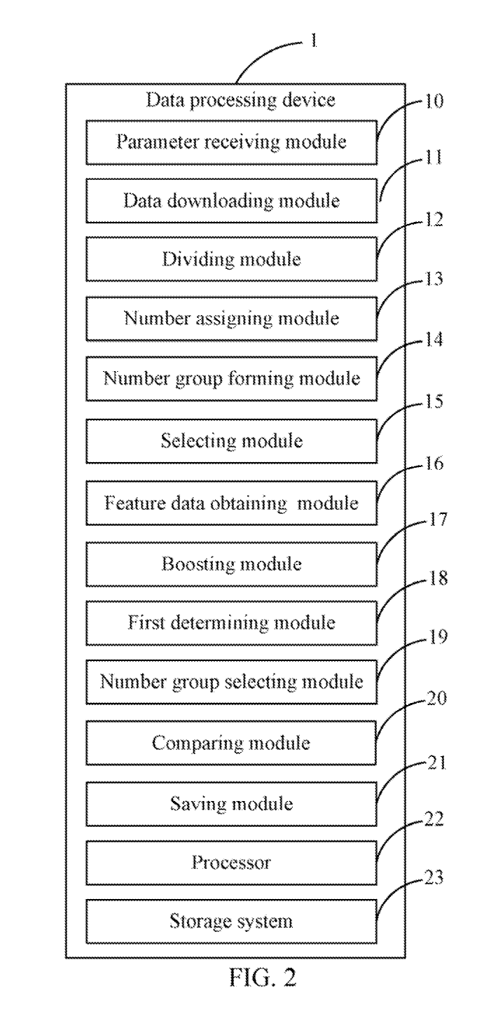

FIG. 2 is a block diagram illustrating one embodiment of function modules of the data processing device 1 in FIG. 1. In the embodiment, the function modules of the data processing device 1 may include a parameter receiving module 10, a data downloading module 11, a dividing module 12, a number assigning module 13, a number group forming module 14, a selecting module 15, a feature data obtaining module 16, a boosting module 17, a determining module 18, a number group selecting module 19, a comparing module 20, and a saving module 21.

In the embodiment, at least one processor 22 of the data processing device 1 executes one or more computerized codes of the function modules 10-21. The one or more computerized codes of the functional modules 10-21 may be stored in a storage system 23 of the data processing device 1.

The parameter receiving module 10 is operable to receive a plurality of acceptable false positive (FP) values from the client computer 2. It may be understood that the FP value is another way of saying “mistake.”

The data downloading module 11 is operable to download given data from the database server 3, and retrieves feature data from the given data to generate a feature set consisting of the feature data.

The dividing module 12 is operable to divide the feature set into several subsets. As mentioned above, the feature set consists of the feature data. In one example, if the number of the feature data is 24, the dividing module 12 may divide the feature set into 6 equal subsets of 4 feature data.

The number assigning module 13 is operable to assign a number to each subset. In one example, if there are 6 subsets, the numbers assigned to the 6 subsets may be 1, 2, 3, 4, 5, and 6, for example.

The number group forming module 14 is operable to form a plurality of number groups, each of which includes N subsets of different numbers, where N is a positive whole number. In one embodiment, N may be 2. The plurality of number groups may be, but not limited to, (1, 2), (1, 3), (1, 4), (2, 4), (2, 5), (2, 6), (3, 4), (3, 5), (4, 5), (5, 6), for example.

The selecting module 15 is operable to select an acceptable FP value one by one from the plurality of received acceptable FP values. In one embodiment, the selection of the acceptable FP value may be according to a descending sequence of the received acceptable FP values.

The feature data obtaining module 16 is operable to select one number group from the plurality of number groups, so as to obtain the feature data included in the N subsets of the selected number group. In one embodiment, the selection of the number group may be random.

The boosting module 17 is operable to form a matrix using the chosen feature data, and compute a value by boosting algorithm according to the matrix.

The determining module 18 is operable to determine if all the number groups have been selected for computing other values by boosting algorithm.

The number group selecting module 19 is operable to rank all the computed values in an ascending order to generate a queue, obtain n computed values seriatim from a start of the queue, and obtain the n number groups corresponding to the n computed values, where n is a positive whole number, and may be 30, for example.

The comparing module 20 is operable to compare the minimum value in the n computed values with the selected acceptable FP value, to determine if the minimum value is less than the selected acceptable FP value.

The number group forming module 14 is further operable to add a subset into each of the n number groups to form n new number groups including N+1 subsets of different numbers, if the minimum value is not less than the selected acceptable FP value.

The saving module 21 is operable to save the minimum value as the FP value of the current operation, and save the number group corresponding to the minimum value into the storage system 23 if the minimum value is less than the selected acceptable FP value.

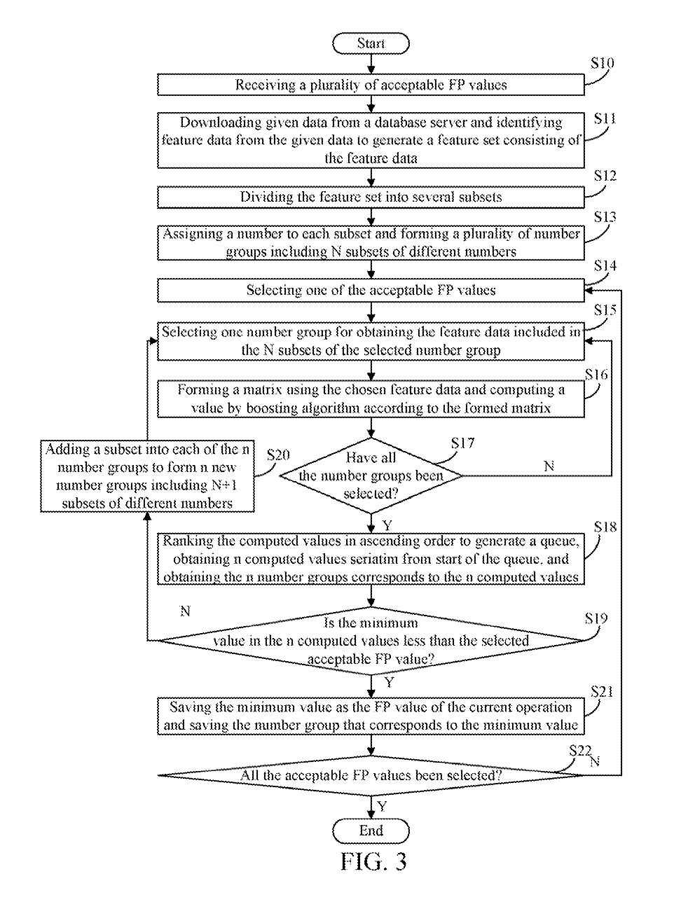

FIG. 3 is a flowchart of one embodiment of a method for simplification of a matrix based boosting algorithm. Depending on the embodiment, additional blocks in the flow of FIG. 3 may be added, others removed, and the ordering of the blocks may be changed.

In block S10, the parameter receiving module 10 receives a plurality of acceptable false positive (FP) values from the client computer 2.

In block S11, the data downloading module 11 downloads given data from the database server 3, and retrieves feature data from the given data to generate a feature set which consists of the feature data.

In block S12, the dividing module 12 divides the feature set into several subsets. In one example, if the number of the feature data is 24, the dividing module 12 may divide the feature set into 6 equal subsets of 4 feature data.

In block S13, the number assigning module 13 assigns a number to each subset, and the number group forming module 14 forms a plurality of number groups, each of which includes N subsets of different numbers, where N is a positive whole number. In one embodiment, N may be 2. In one example, if there are 6 subsets, the numbers assigned to 6 subsets may be 1, 2, 3, 4, 5, and 6, and the plurality of number groups may be, but not limited to, (1, 2), (1, 3), (1, 4), (2, 4), (2, 5), (2, 6), (3, 4), (3, 5), (4, 5), (5, 6), for example.

In block S14, the selecting module 15 select an acceptable FP value from the plurality of received acceptable FP values.

In block S15, the feature data obtaining module 16 selects one number group from the plurality of number groups for obtaining the feature data included in the N subsets of the selected number group. In one embodiment, the selection of the number group may be random.

In block S16, the boosting module 17 forms a matrix using the chosen feature data, and computes a value by boosting algorithm according to the matrix.

In block S17, the determining module 18 determines if all the number groups have been selected. If at least one number group has not been selected, block S15 is repeated. If all the number groups have been selected, block S18 is implemented.

In block S18, the number group selecting module 19 ranks all the computed values in an ascending order to generate a queue, obtains n computed values seriatim from a start of the queue, and obtains n number groups corresponding to the n computed values, where n is a positive whole number, may be 30, for example.

In block S19, the comparing module 20 compares the minimum value in the n computed values with the selected acceptable FP value to determine if the minimum value is less than the selected acceptable FP value. If the minimum value is not less than the selected acceptable FP value, block S20 is implemented. If the minimum value is less than the selected acceptable FP value, block S21 is implemented

In block S20, the number group forming module 14 adds a subset into each of the n number groups to form n new number groups including N+1 subsets of different numbers.

In block S21, the saving module 21 saves the minimum value as the FP value of the current operation, and saves the number group that corresponds to the minimum value into the storage system 23.

In block S22, the selecting module 15 determines if all the plurality of received acceptable FP values have been selected, so as to select next acceptable FP value. If at least one received acceptable FP value has not been selected, block S14 is repeated. Otherwise, if all the received acceptable FP values have been selected, the flow ends.

The method for simplification a matrix based boosting algorithm proposed above can help to reduce memory space and operation time required. With this method, given data can be separated into many segments. Each segments only need to perform operation through part of feature data. Hence, it can spend less time to achieve identical false positive value compared with original method.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for simplification of a matrix based boosting algorithm, the method being performed by execution of computer readable program code by at least one processor of at least one computer system, the method comprising:
(a) dividing a feature set comprising a plurality of feature data into several subsets;
(b) assigning a number to each subset, and forming a plurality of number groups including N subsets of different numbers, wherein N is a positive whole number;
(c) selecting one number group from the plurality of number groups for selecting the feature data included in the N subsets of the selected number group;
(d) forming a matrix using the chosen feature data, and computing a value by boosting algorithm according to the matrix;
(e) repeating blocks (c) and (d) until all the number groups have been selected for computing a plurality of values by the boosting algorithm;
(f) ranking all the computed values in an ascending order to generate a queue, obtaining n computed values seriatim from a start of the queue, and obtaining n number groups corresponding to the n computed values, wherein n is a positive whole number;
(g) comparing the minimum value in the n computed values with an predetermined acceptable false positive (FP) value to determine if the minimum value is less than the predetermined acceptable FP value; and
(h) saving the minimum value as the FP value of the current operation, and saving the number group that corresponds to the minimum value, upon condition that the minimum value is less than the predetermined acceptable FP value.

2. The method as described in claim 1, wherein the feature data is retrieved from given data downloaded from a database server.

3. The method as described in claim 1, wherein the predetermined acceptable FP value is one of a plurality of acceptable FP values received from a client computer.

4. The method as described in claim 1, further comprising:
adding a subset into each of the n number groups to form n new number groups including N+1 subsets of different numbers, upon condition that the minimum value is not less than the predetermined acceptable FP value; and
repeating blocks (f) to (j) according to the n new number groups.

5. The method as described in claim 4, wherein N is 2.

6. The method as described in claim 4, wherein n is 30.

7. A storage medium having stored thereon instructions that, when executed by a processor, cause the processor to perform a method for simplification of a matrix based boosting algorithm, wherein the method comprises:
(a) dividing a feature set comprising a plurality of feature data into several subsets;
(b) assigning a number to each subset, and forming a plurality of number groups including N subsets of different numbers, wherein N is a positive whole number;
(c) selecting one number group from the plurality of number groups for selecting the feature data included in the N subsets of the selected number group;
(d) forming a matrix using the chosen feature data, and computing a value by boosting algorithm according to the matrix;
(e) repeating blocks (c) and (d) until all the number groups have been selected for computing a plurality of values by the boosting algorithm;
(f) ranking all the computed values in an ascending order to generate a queue, obtaining n computed values seriatim from a start of the queue, and obtaining n number groups corresponding to the n computed values, wherein n is a positive whole number;
(g) comparing the minimum value in the n computed values with an predetermined acceptable false positive (FP) value to determine if the minimum value is less than the predetermined acceptable FP value; and
(h) saving the minimum value as the FP value of the current operation, and saving the number group that corresponds to the minimum value, upon condition that the minimum value is less than the predetermined acceptable FP value.

8. The storage medium as described in claim 7, wherein the feature data is retrieved from given data downloaded from a database server.

9. The storage medium as described in claim 7, wherein the predetermined acceptable FP value is one of a plurality of acceptable FP values received from a client computer.

10. The storage medium as described in claim 7, wherein the method further comprises:
adding a subset into each of the n number groups to form n new number groups including N+1 subsets of different numbers, upon condition that the minimum value is not less than the predetermined acceptable FP value; and
repeating blocks (f) to (j) according to the n new number groups.

11. The storage medium as described in claim 10, wherein N is 2.

12. The storage medium as described in claim 10, wherein n is 30.

13. A computer-based system for simplification of a matrix based boosting algorithm, comprising:
a dividing module operable to divide a feature set comprising a plurality of feature data into several subsets;
a number assigning module operable to assign a number to each subset;
a number group forming module operable to form a plurality of number groups including N subsets of different numbers, wherein N is a positive whole number;
a feature data obtaining module operable to select one number group from the plurality of number groups, so as to obtain the feature data included in the N subsets of the selected number group;
a boosting module operable to form a matrix using the chosen feature data, and compute a value by boosting algorithm according to the matrix;
a determining module operable to determine if all the number groups have been selected for computing other values by the boosting algorithm;
a number group selecting module operable to rank all the computed values in an ascending order to generate a queue, obtain n computed values seriatim from a start of the queue, and obtain n number groups corresponding to the n computed values, where n is a positive whole number;
a comparing module operable to compare the minimum value in the n computed values with a predetermined acceptable false positive (FP) value to determine if the minimum value is less than a predetermined acceptable FP value;
a saving module operable to save the minimum value as the FP value of the current operation, and save the number group that corresponds to the minimum value, upon condition that the minimum value is less than the predetermined acceptable FP value; and
a processor that executes the dividing module, the number assigning module; the number group forming module, the feature data obtaining module; the boosting module, the determining module, the number group selecting module, the comparing module, and the saving module.

14. The system as described in claim 13, further comprising:
a data downloading module operable to download given data that comprise the feature data from a database server.

15. The system as described in claim 13, further comprising:
a parameter receiving module operable to receive a plurality of acceptable FP values that comprises the predetermined acceptable FP value from a client computer.

16. The system as described in claim 13, wherein the number group forming module is further operable to add a subset into each of the n number groups to form n new number groups including N+1 subsets of different numbers, upon condition that the minimum value is not less than the predetermined acceptable FP value.

17. The system as described in claim 16, wherein N is 2.

18. The system as described in claim 16, wherein n is 30.
